(19) United States
(12) Patent Application Publication
(10) Pub. No.: US 2024/0207125 A1
(43) Pub. Date: Jun. 27, 2024

(54) MOVEMENT ASSIST DEVICE AID

(71) Applicant: CrutchAid LLC, Austin, TX (US)

(72) Inventor: Nathan Paul Hagstrom, Minneapolis, MN (US)

(73) Assignee: CrutchAid LLC, Austin, TX (US)

(21) Appl. No.: 18/390,466

(22) Filed: Dec. 20, 2023

Related U.S. Application Data
(60) Provisional application No. 63/476,798, filed on Dec. 22, 2022.

(51) Int. Cl. A61H 3/02

(52) U.S. Cl. CPC A61H 3/02; A61H 2003/002; A61H 2201/0107

(57) ABSTRACT

A movement assist device aid includes a mount assembly and an attachment assembly. The mount assembly includes a shaft mount and a first magnet positioned within the shaft mount. The first magnet includes a first central axis. The attachment assembly includes a second magnet. The second magnet includes a second central axis. The first magnet of the mount assembly and the second magnet of the attachment assembly are configured to magnetically engage with each other to secure the attachment assembly to the mount assembly. The first central axis of the first magnet is offset from the second central axis of the second magnet when the attachment assembly is secured to the mount assembly.

### CROSS REFERENCE TO RELATED APPLICATIONS

This application is based on, claims priority to, and incorporates herein by reference in its entirety U.S. Provisional Application No. 63/476,798, filed on Dec. 22, 2022, and entitled “MOVEMENT ASSIST DEVICE AID.”

### BACKGROUND OF THE DISCLOSURE

### 1. Field of the Disclosure

The present disclosure relates generally to movement assist device aids and, more particularly, to a device useful for assisting a user with holding components while using a movement assist device, such as a crutch.

### 2. Description of the Background of the Disclosure

People with physical disabilities such as the elderly, the handicapped, as well as those recovering from injuries or surgery often encounter difficulties while performing tasks that most people take for granted. What comes easily to those without disabilities, such as climbing stairs or dressing themselves, can become very difficult or even impossible to do without assistance. For example, those who require crutches lack the free use of their hands while moving about, which can make doing trivial things, such as carrying items, very difficult.

Accordingly, there exists a need for a device that helps a user transport daily goods and products when the ability to do so is limited by use of a movement assist device.

### SUMMARY OF THE INVENTION

According to a first aspect, a movement assist device aid comprises a mount assembly and an attachment assembly. The mount assembly includes a shaft mount and a first magnet positioned within the shaft mount. The first magnet comprises a first central axis. The attachment assembly comprises a second magnet. The second magnet comprises a second central axis. The first magnet of the mount assembly and the second magnet of the attachment assembly are configured to magnetically engage with each other to secure the attachment assembly to the mount assembly. The first central axis of the first magnet is offset from the second central axis of the second magnet when the attachment assembly is secured to the mount assembly.

In some embodiments, the attachment assembly is a cup holder. In some embodiments, a slot extends into an upper surface of the shaft mount. In some embodiments, the shaft mount includes an aperture that extends through the shaft mount. The first magnet is positioned within the aperture. In some embodiments, the attachment assembly includes a flange that is configured to mate within the slot of the shaft mount to attach the attachment assembly to the mount assembly. In some embodiments, the flange comprises a bore therein. The bore extends into an outer surface of the flange and is configured to receive and retain the second magnet therein.

According to another aspect, a movement assist device aid comprises a mount assembly and an attachment assembly. The mount assembly includes a shaft mount, a mounting pin, and a first magnet. The mount assembly is configured to be removably attached to a crutch. The attachment assembly includes an attachment element and a second magnet. The attachment assembly is configured to be removably attached to the mount assembly. The crutch includes a grip. The mount assembly is attached to the crutch above the grip in a first configuration.

In some embodiments, the attachment element is a cup holder. In some embodiments, the mounting pin is configured to be inserted into a locating hole of the crutch. In some embodiments, the shaft mount includes a pair of flexible arms that form a concave surface that is configured to contact the crutch. In some embodiments, the mounting pin extends into an aperture that extends through the concave surface of the flexible arms. In some embodiments, the first magnet is in contact with the mounting pin.

According to yet another aspect, a movement assist device aid comprises a mount assembly and an attachment assembly. The mount assembly includes a shaft mount that comprises a housing and flexible arms. The attachment assembly is configured to be removably attached to the mount assembly. The flexible arms are configured to secure the movement assist device aid to a movement assist device.

In some embodiments, the shaft mount includes a plurality of linkage members on both sides of the flexible arms. In some embodiments, the housing, the flexible arms, and the plurality of linkage members define a four-bar component on both sides of the flexible arms. In some embodiments, a plurality of joints are connected with the plurality of linkage members. In some embodiments, movement of the plurality of linkage members and the plurality of joints cause deflection of the flexible arms. In some embodiments, the attachment assembly is a cup holder. In some embodiments, the mount assembly includes a first magnet and the attachment assembly includes a second magnet. The first magnet and the second magnet are configured to magnetically engage with each other to secure the attachment assembly to the mount assembly. In some embodiments, the first magnet is coaxially offset with the second magnet when the attachment assembly is secured to the mount assembly.

### BRIEF DESCRIPTION OF THE DRAWINGS

FIG. 1 is an isometric view of a rear, top, and right side of a movement assist device and a movement assist device aid in accordance with the present disclosure;

FIG. 2 is an isometric view of a front, top, and right side of the movement assist device aid of FIG. 1;

FIG. 3 is a front elevational view of the movement assist device aid of FIG. 1;

FIG. 4 is a rear elevational view of the movement assist device aid of FIG. 1;

FIG. 5 is a right side elevational view of the movement assist device aid of FIG. 1;

FIG. 6 is a left side elevational view of the movement assist device aid of FIG. 1;

FIG. 7 is a top plan view of the movement assist device aid of FIG. 1;

FIG. 8 is a bottom plan view of the movement assist device aid of FIG. 1;

FIG. 9 is a cross-sectional view of the movement assist device and the movement assist device aid taken through line 9-9 of FIG. 1;

FIG. 10 is a rear, top, and right side isometric view of a mount assembly of the movement assist device aid of FIG. 1;

FIG. 11 is a top plan view of the mount assembly of FIG. 10;

FIG. 12 is a front, top, and right side isometric view of an attachment assembly of the movement assist device aid of FIG. 1;

FIG. 13 is a right side elevational view of the attachment assembly of FIG. 12;

FIG. 14 is an isometric view of a front, top, and right side of a mount assembly, according to another embodiment of the present disclosure; and

FIG. 15 is a top plan view of the mount assembly of FIG. 14.

### DETAILED DESCRIPTION

The present disclosure is directed to a movement assist device aid or crutch aid that is used for mounting various components to a shaft of a movement assist device. The mounted components can assist a user using a movement assist device. While the present disclosure may be embodied in many different forms, several specific embodiments are discussed herein with the understanding that the present disclosure is to be considered only an exemplification of the principles of the disclosure, and it is not intended to limit the disclosure to the embodiments illustrated. Throughout the disclosure, the terms “about” and “approximately” refer to a range of values ±5% of the numeric value that each term precedes. As noted herein, all ranges disclosed within this application are inclusive of the outer bounds of the range.

Although the current embodiment includes a crutch as the movement assist device and is referred to as a crutch aid, it is noted herein that the movement assist device aid or crutch aid can be used with any type of movement assist device, e.g., crutches, walkers, canes, wheelchairs, or the like. Therefore, the term “crutch aid” simply names the device and does not limit the use to just crutches.

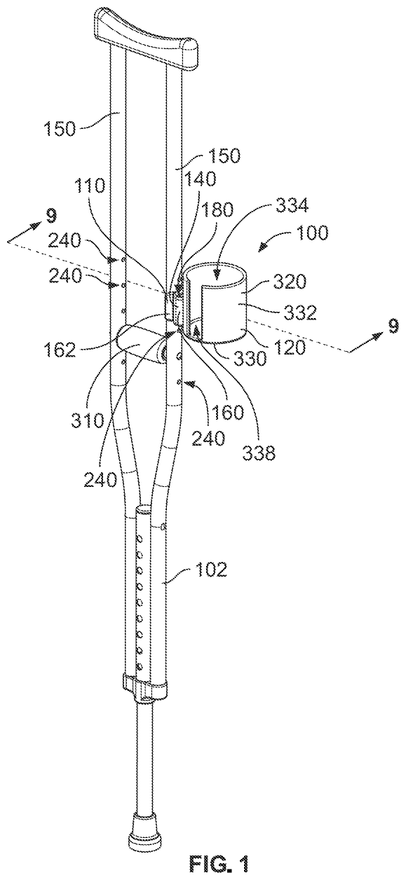

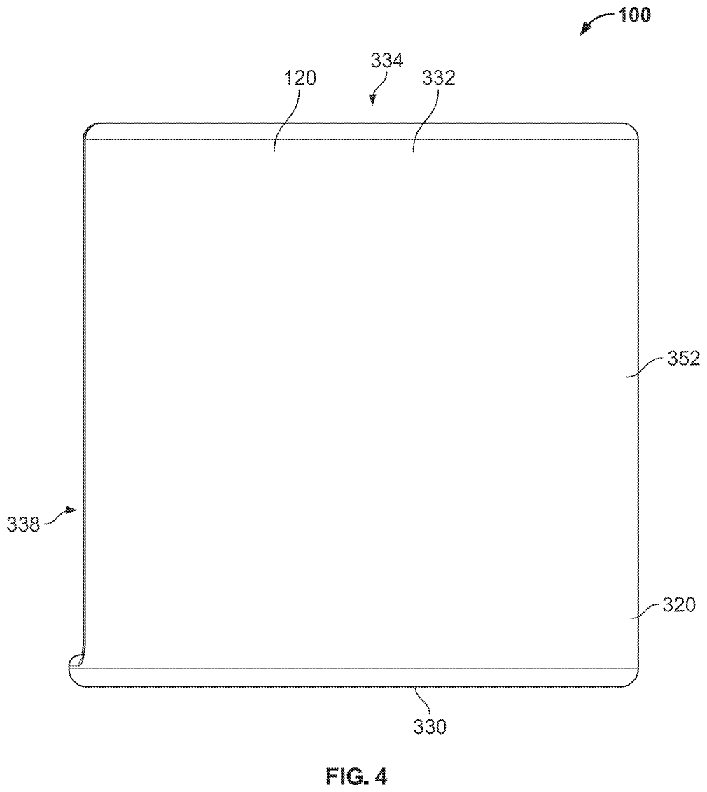

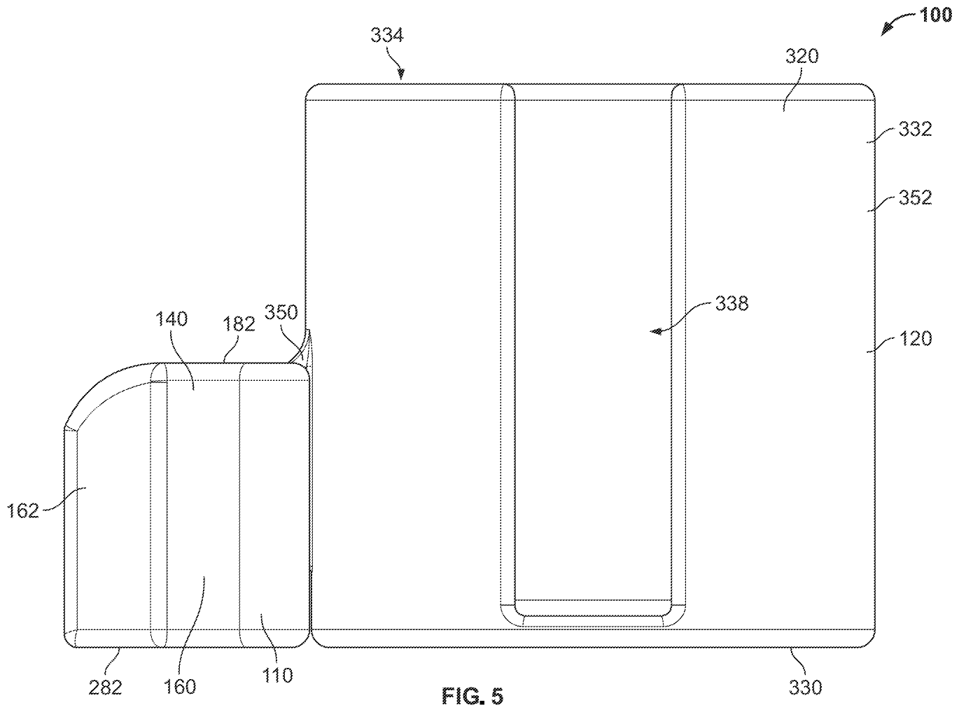

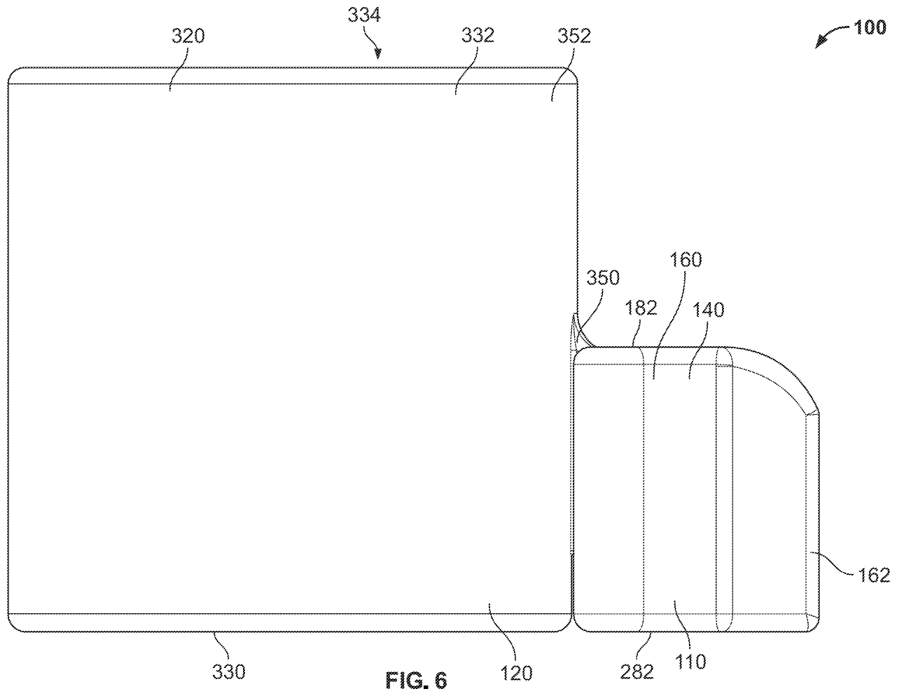

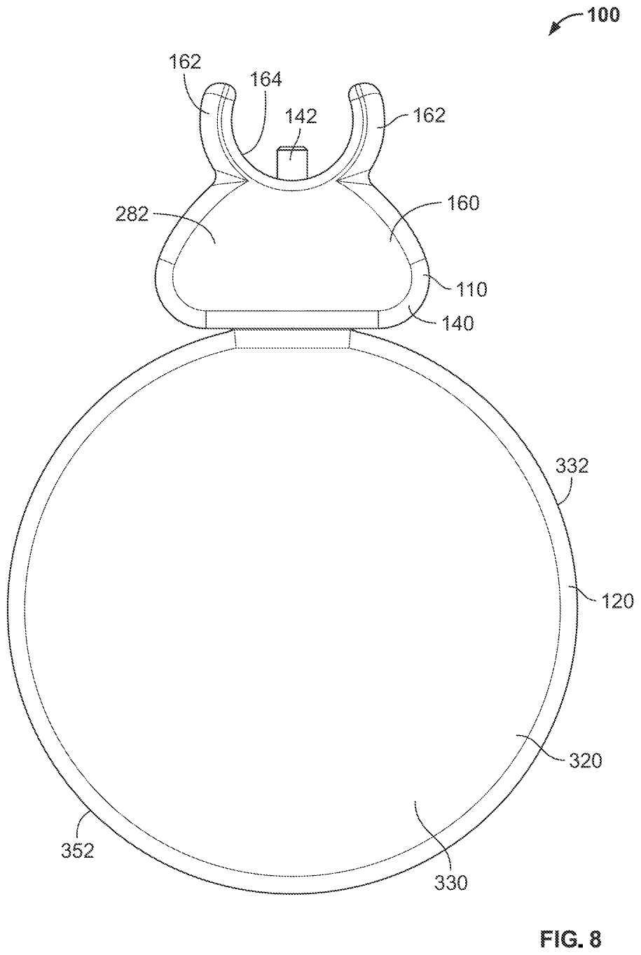

Referring now to the drawings, FIGS. 1-9 depict a movement assist device aid or crutch aid 100. Referring specifically to FIG. 1, the crutch aid 100 is configured to attach to a movement assist device 102. As discussed above, the present embodiment illustrates the movement assist device 102 as a crutch. However, it is noted that the movement assist device 102 can be any type of movement assist device. For example, in some embodiments, the movement assist device 102 can be a walker, a cane, a wheelchair, a walking frame, a walking stick, a tricycle, a prosthetic, a clubfoot brace, and/or a scooter. The crutch aid 100 can be attached to any portion of the movement assist device 102 to assist a user. The crutch aid 100 can be injection molded, 3D printed, or manufactured using any other suitable type of manufacturing process. Further, the crutch aid 100 can be manufactured from any suitable material such but not limited to engineering plastic or polymeric materials. In some embodiments, the crutch aid 100 may be manufactured from ABS.

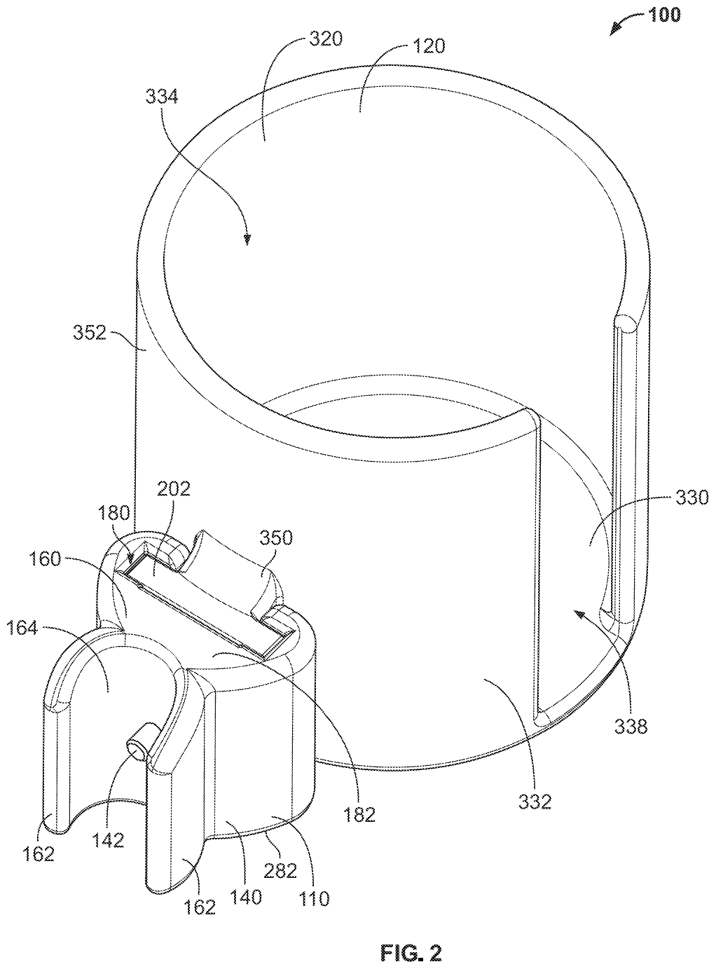

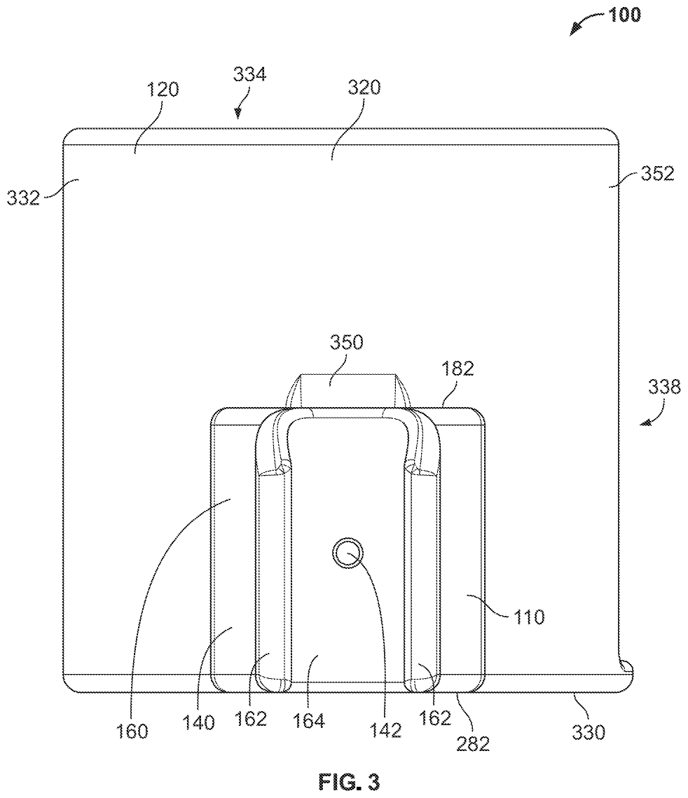

Referring to FIGS. 2 and 3, the crutch aid 100 includes a mount assembly 110 and an attachment assembly 120. The mount assembly 110 is configured to attach to the movement assist device 102 and hold the attachment assembly 120 in place. The attachment assembly 120 is configured to secure to the mount assembly 110 and assist the user during use. In the present embodiment, the attachment assembly 120 includes a cupholder that can be used to hold a beverage of the user. However, it is contemplated that the attachment assembly 120 may include any type of device to assist the user using the movement assist device 102. For example, in some embodiments, the attachment assembly 120 may include a phone holder, a multi-purpose gripper, a crutch hanger, a purse hook, a hook, or a myriad of other useful attachments. For the purposes of illustration, the present embodiment illustrates the attachment assembly 120 as including a cupholder. However, the attachment assembly 120 is not limited to only a cupholder.

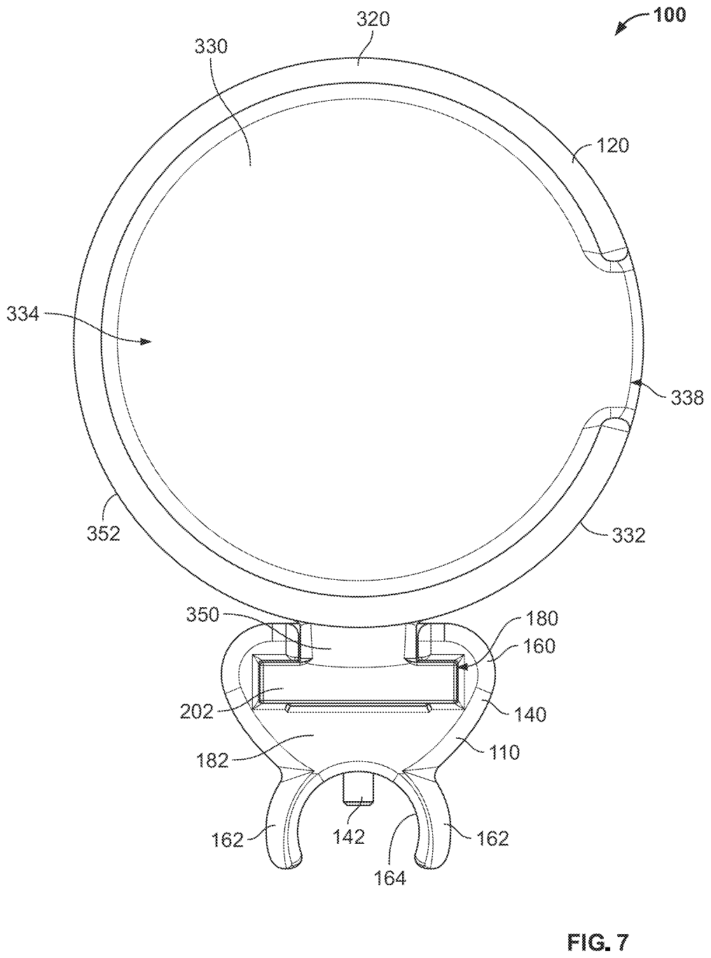

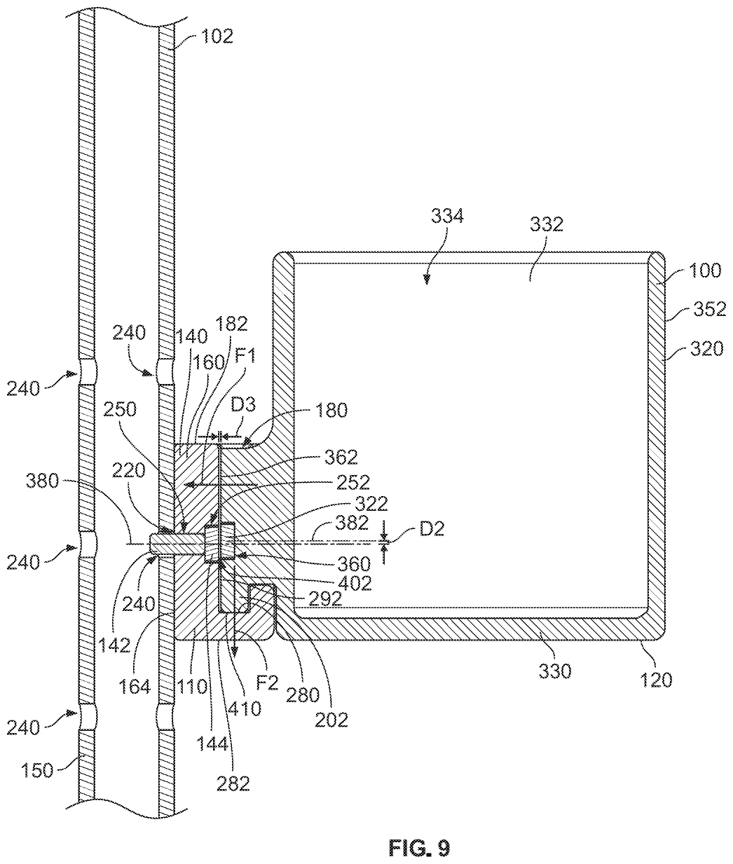

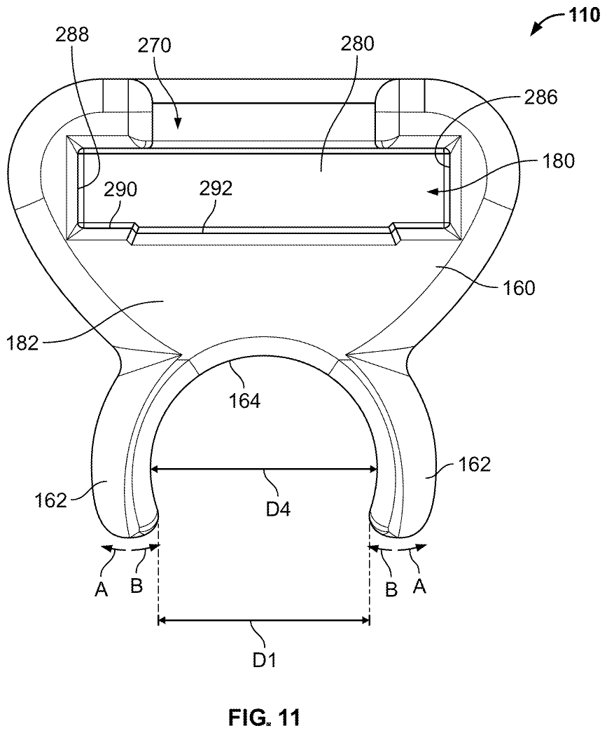

Still referring to FIGS. 2 and 3, the mount assembly 110 includes a shaft mount 140, a mounting pin 142, and a first magnet 144 (see FIG. 9). The shaft mount 140 attaches to a shaft 150 of the movement assist device 102 and includes a housing 160 and a pair of flexible arms 162. The flexible arms 162 extend outwardly from the housing 160 and comprise a generally U-shape from above (see FIG. 7). In other words, the flexible arms 162 form a concave surface 164 that is configured to contact the shaft 150 of the movement assist device 102. As noted herein, the concave surface 164 disclosed herein forms a part of an imaginary circle, i.e., forms part of a circular shape. However, in some embodiments, the concave surface 164 may form a different shape or part of a different shape. For example, in some embodiments, the concave surface 164 may form part of an elliptic shape, diamond shape, an oval shape, etc. The flexible arms 162 can be moved or biased to attach to the movement assist device 102. Specifically, the flexible arms 162 are designed to articulate by a prescribed distance when attached to the shaft 150 of the movement assist device 102. The magnitude of the prescribed distance in concert with the stiffness of the flexible arms 162 allows the shaft mount 140 to provide sufficient frictional force to attach to the shaft 150 with minimal rotational or translational movement. In other words, the flexible arms 162 are deflectable in the direction of arrows A and B (see FIG. 11) and are used to snap onto the shaft 150 of the movement assist device 102. Therefore, the flexible arms 162 create a snap fit connection between the shaft mount 140 and the shaft 150 of the movement assist device 102. The stiffness of the flexible arms 162 enables low effort mounting of the mount assembly 110 to the movement assist device 102 to improve simplicity of installation. In some embodiments, the mount assembly 110 may not include the flexible arms 162. For example, in some embodiments, the mount assembly 110 may be secured to the shaft 150 of the movement assist device 102 by a clip, a fastener, a magnet, an adhesive, and/or a bolt. Therefore, it is contemplated that the mount assembly 110 may be secured to the shaft 150 of the movement assist device 102 by any configuration.

Still referring to FIGS. 2 and 3, the flexible arms 162 assist in securing the crutch aid 100 to the movement assist device 102. In some embodiments, the concave surface 164 of the flexible arms 162 may include a prescribed surface roughness and/or gripping features to increase frictional forces on the shaft 150. Further, in some embodiments, the concave surface 164 of the flexible arms 162 may comprise a thin film to increase friction between the shaft 150 of the movement assist device 102 and the shaft mount 140. Furthermore, in some embodiments, the concave surface 164 of the flexible arms 162 may comprise both a prescribed surface roughness and a thin film to increase frictional forces on the movement assist device 102. As illustrated in FIG. 11, the flexible arms 162 may comprise a distance D1 of between 20% and 100% of a distance D4, i.e., a maximum diameter tangent to three points on the concave surface 164. In some embodiments, the distance D1 is between 50% and 90% of the distance D4. Further, in some embodiments, the distance D1 is between 70% and 80% of the distance D4. Furthermore, in some embodiments, the distance D1 is 75% of the distance D4.

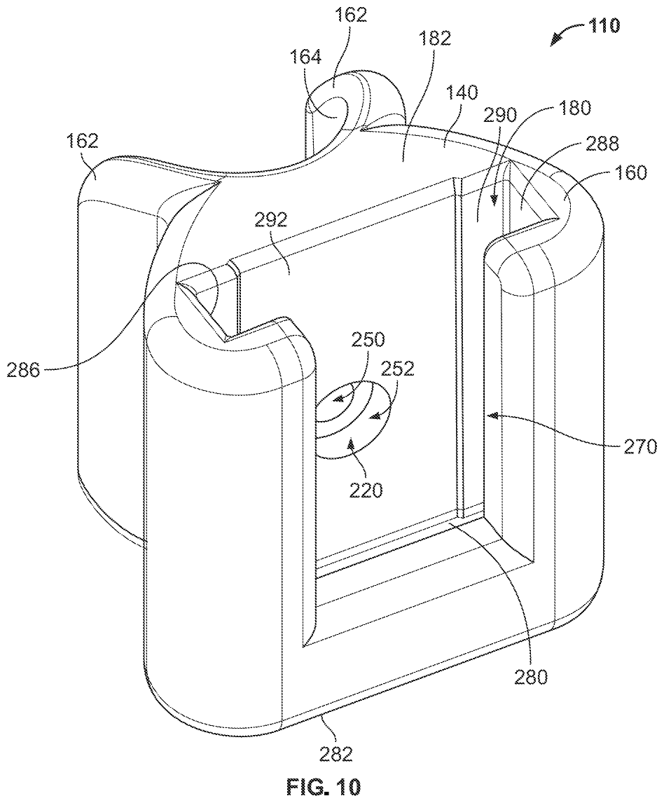

Referring to FIG. 2, the shaft mount 140 comprises a slot 180 that extends into an upper surface 182 of the shaft mount 140. The slot 180 is configured to receive a flange 202 of the attachment assembly 120 and secure the attachment assembly 120 to the shaft mount 140. Referring again to FIGS. 2 and 3, the mounting pin 142 is illustrated extending outwardly from the flexible arms 162. Specifically, the mounting pin 142 extends into an aperture 220 (see FIG. 10) that extends through the concave surface 164 of the flexible arms 162 and the housing 160 of the shaft mount 140. The mounting pin 142 is secured within the aperture 220 and is configured to assist in attaching the crutch aid 100 to the movement assist device 102. In particular, the mounting pin 142 is useful in increasing the axial stability of the shaft mount 140 when placed on the movement assist device 102. As illustrated in FIG. 9, the mounting pin 142 is sized and configured to fit into locating holes 240 along the shaft 150 of the movement assist device 102. In some embodiments, the mounting pin 142 may be removable by the user in the case the functionality is not desired or required. Therefore, in some embodiments, the mount assembly 110 may not include the mounting pin 142, i.e., the mount assembly 110 can securely attach to the shaft 150 of the movement assist device 102 without the use of the mounting pin 142.

Referring now to FIG. 9, the first magnet 144 and the aperture 220 are illustrated in detail. As illustrated in FIG. 9, the aperture 220 is a counterbored hole that comprises a first region 250 and a second region 252. The second region 252 comprises a larger diameter than the first region 250; however, in some embodiments, the second region 252 of the aperture 220 may have the same diameter as or comprise a smaller diameter than the first region 250. As further illustrated in FIG. 9, the mounting pin 142 is positioned within the first region 250 of the aperture 220 and the first magnet 144 is positioned within the second region 252 of the aperture 220. The first magnet 144 is illustrated as being in contact with the mounting pin 142; however, in some embodiments, the mounting pin 142 may be spaced from the first magnet 144. The first magnet 144 is configured to secure the mounting pin 142 to the shaft mount 140. In other words, the first magnet 144 enables an adhesive-free bond between the mounting pin 142 and the shaft mount 140. The first magnet 144 creates a secure attachment between the mounting pin 142 and the shaft mount 140, but also allows for removal of the mounting pin 142 when desired. As will be discussed in further details herein, the first magnet 144 is configured to enable a magnetic suspension between the mount assembly 110 and the attachment assembly 120. In preferred embodiments, the first magnet 144 is a magnet disk. However, it is contemplated that the first magnet 144 may comprise any type of magnet.

Referring now to FIGS. 10 and 11, the slot 180 of the shaft mount 140 is shown in more detail. As discussed above, the slot 180 extends into the upper surface 182 of the shaft mount 140 and forms a window 270 in the housing 160 of the shaft mount 140. The second region 252 of the aperture 220 terminates at the slot 180 of the shaft mount 140. As illustrated in FIG. 10, the slot 180 extends into the housing 160 of the shaft mount 140 and is defined by a floor 280 adjacent a lower surface 282 of the shaft mount 140. Therefore, the slot 180 does not extend entirely through the shaft mount 140. However, in some embodiments, the slot 180 may extend entirely through the housing 160 of the shaft mount 140.

Still referring to FIGS. 10 and 11, the slot 180 is defined by a first sidewall 286, a second sidewall 288, and a third sidewall 290. The third sidewall 290 is opposite the window 270 and comprises a recessed wall 292 that extends from the upper surface 182 of the shaft mount 140 to the floor 280. As illustrated in FIG. 11, the slot 180 defines a generally rectangular cross section. However, in some embodiments, the slot 180 may comprise a triangular, a trapezoidal, a circular, or square cross section. As noted herein, the shaft mount 140 is a single-formed or unitary piece.

Referring to FIGS. 1-3 and 9-11, a method of securing the mount assembly 110 to the movement assist device 102 is disclosed. Specifically, the mounting pin 142 is inserted into the aperture 220 and the mount assembly 110 is placed in a position such that the mounting pin 142 is aligned with one of the locating holes 240 on the shaft 150 of the movement assist device 102. The user may then push the mount assembly 110 onto the shaft 150 of the movement assist device 102 in order to have the flexible arms 162 deflect outwardly in the direction of arrows A and snap onto the shaft 150 in the direction of arrows B (see FIG. 11). As the flexible arms 162 are deflecting in the direction of arrows A and the user is moving the mount assembly 110 toward the shaft 150, the mounting pin 142 is inserted into one of the locating holes 240 on the shaft 150 of the movement assist device 102. Once the flexible arms 162 snap back in the direction of arrows B and the mounting pin 142 is secured within one of the locating holes 240 of the shaft 150, the mount assembly 110 is secured to the movement assist device 102. In order to remove the mount assembly 110, the user only needs to deflect the flexible arms 162 in the direction of arrows A and pull the mount assembly 110 away from the shaft 150 of the movement assist device 102. In some embodiments, the user may deflect the flexible arms 162 in the direction of arrows A prior to pushing the mount assembly 110 onto the shaft 150 in order to secure the mount assembly 110 to the movement assist device 102.

As discussed above, the mounting pin 142 does not need to be used in order to secure the mount assembly 110 to the movement assist device 102. Therefore, the flexible arms 162 are configured to substantially secure the mount assembly 110 to the movement assist device 102. However, it is noted herein that the mounting pin 142 allows for greater securement between the mount assembly 110 and the movement assist device 102. As noted herein, the mount assembly 110 can be secured to the shaft 150 of the movement assist device 102 with or without the attachment assembly 120 secured to the mount assembly 110. Further, in some embodiments, when the mounting pin 142 is used, the crutch aid 100 can hold between about 60 pounds and about 150 pounds, or between about 70 pounds and about 110 pounds, or between about 70 pounds and about 90 pounds, or about 80 pounds, or at least about 60 pounds, or at least about 70 pounds, or at least about 80 pounds.

Referring back to FIG. 1, it is beneficial to place the mount assembly 110 above a grip 310 of the movement assist device 102 for ergonomic purposes, i.e., in a first configuration. As noted herein, the weight associated with the crutch aid 100 and the element the crutch aid 100 is holding will feel the least to the user the higher the crutch aid 100 is placed. Therefore, it is beneficial to place the crutch aid 100, i.e., the mount assembly 110, as high as possible along the movement assist device 102, preferably above the grip 310 of the movement assist device 102 (see FIG. 1). However, in some embodiments, the crutch aid 100 may be placed below the grip 310 of the movement assist device 102. Therefore, it is contemplated that the crutch aid 100 may be placed anywhere on the movement assist device 102 and in many different configurations. In some embodiments, the mount assembly 110 may be attached to the movement assist device 102 above the grip 310 in a first configuration and be removed from the movement assist device 102 in a second configuration.

Referring again to FIG. 9, the attachment assembly 120 comprises an attachment element 320 and a second magnet 322. As discussed above, the attachment element 320 may be a cup holder; however, the attachment element 320 may be another similar device useful in daily activity to assist the user. As illustrated in FIG. 9, the second magnet 322 may be a magnet disk. However, in some embodiments, the second magnet 322 may be a ferrous steel disk and not a magnet. Further, in some embodiments, the first magnet 144 may also not be a magnet. Therefore, in some embodiments, only one of the first magnet 144 and the second magnet 322 may be a magnet. The other non-magnet may be just a ferrous steel disk or a device with a magnetic material, e.g., metal.

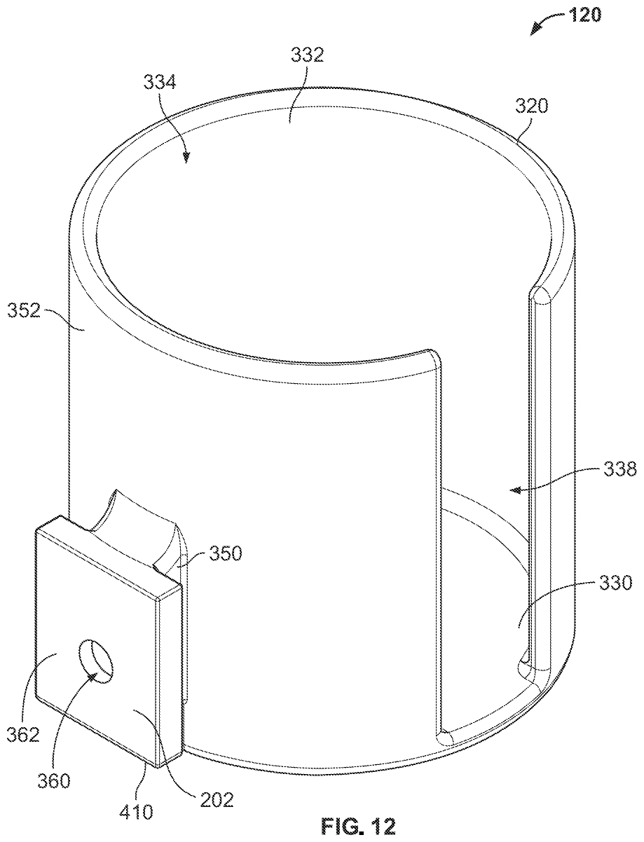

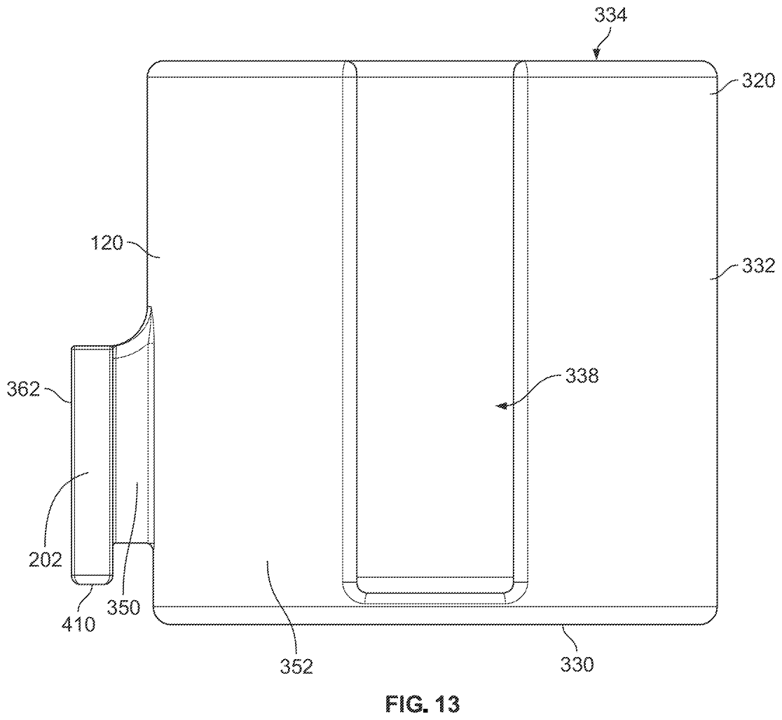

Referring now to FIGS. 12 and 13, the attachment assembly 120 is shown in more detail. The attachment element 320 comprises a base 330 that includes a generally circular shape. The base 330 is planar; however, in some embodiments, the base 330 may include a plurality of ribs, recesses, and/or grooves to help securely retain a component, e.g., a beverage, therein. A rounded sidewall 332 extends upwardly from the base 330 and defines a cavity 334. As illustrated in FIGS. 12 and 13, the rounded sidewall 332 comprises an opening 338 therein. The opening 338 has a generally U-shape and is positioned about 900 angularly offset from the flange 202. The opening 338 allows the user better access to the cavity 334 of the attachment element 320. In some embodiments, the attachment element 320 may not include the opening 338 or the opening 338 may be positioned on a different location of the rounded sidewall 332. As discussed above, the cavity 334 of the attachment element 320 is configured to retain a beverage therein. However, it is contemplated that the attachment element 320 may be used to retain other elements than just a beverage. For example, in some embodiments, the cavity 334 may hold a phone, garbage, glasses, and/or various features used by the user. Therefore, in some embodiments, the attachment element 320 can act as a storage container for the user.

Still referring to FIGS. 12 and 13, a flange support 350 extends outwardly from an exterior 352 of the rounded sidewall 332 and is secured with the flange 202. The flange 202 comprises a generally rectangular shape; however, it is contemplated that the flange 202 may comprise any type of shape. In preferred embodiments, the flange 202 has a shape that corresponds with (and is complementary with) the shape of the slot 180 of the shaft mount 140. Therefore, the flange 202 is configured to mate with the slot 180 in order to attach the attachment assembly 120 to the mount assembly 110. As will be discussed in further details herein, the interaction between the flange 202 of the attachment assembly 120 and the slot 180 of the shaft mount 140 and the interaction between the first magnet 144 and the second magnet 322 secure the attachment assembly 120 to the mount assembly 110. As illustrated in FIG. 12, the flange 202 comprises a bore 360 therein. The bore 360 extends into an outer surface 362 of the flange 202 and is configured to receive and retain the second magnet 322 therein (see FIG. 9).

Referring again to FIG. 9, the attachment assembly 120 and the mount assembly 110 interact with each other through magnetic suspension. This suspension is important to ensure a secure attachment between the attachment assembly 120 and the mount assembly 110, while also allowing for simple removal of the attachment assembly 120. The suspension is designed to create both an axial magnet force F1 and a perpendicular magnet force F2 between the first magnet 144 and the second magnet 322. This magnetic force is prescribed by intentional misalignment between the first magnet 144 and the second magnet 322. By intentionally misaligning (or offsetting) the central axis of the first magnet 144 and the second magnet 322, it is possible to create a suspension where the first magnet 144 is perpetually pulling on the second magnet 322, allowing for stable but non-permanent coupling between the mount assembly 110 and the attachment assembly 120. In other words, the first magnet 144 comprises a first central axis 380 and the second magnet 322 comprises a second central axis 382. As illustrated in FIG. 9, the first central axis 380 is offset from the second central axis 382, i.e., the second central axis 382 is positioned above the first central axis 380. In other words, the first magnet 144 is coaxially offset with the second magnet 322 when the attachment assembly 120 is secured to the mount assembly 110. However, in some embodiments, the second central axis 382 may be positioned below the first central axis 380. As illustrated in FIG. 9, a distance D2 between the first central axis 380 and the second central axis 382 is between about 0.1 mm and about 10 mm, or between about 0.1 mm and about 2 mm, or between about 0.1 mm and about 1 mm, or between about 0.3 mm and about 0.8 mm, or between about 0.4 mm and about 0.6 mm, or about 0.5 mm, or at least about 0.1 mm, or at least about 0.2 mm, or at least about 0.3 mm, or at least about 0.4 mm, or at least about 0.5 mm. In some embodiments, the first magnet 144 may be aligned with the second magnet 322, i.e., the distance D2 is zero.

As illustrated in FIG. 9, the first magnet 144 and the second magnet 322 have a cylindrical shape. However, in some embodiments, the first magnet 144 and/or the second magnet 322 may have a different shape. For example, the first magnet and/or the second magnet 322 may have a spherical, cubical, conical, trapezoidal, rectangular, elliptical, hemispheric, diamond, cuboid, triangle, torus, annular, pyramid, wedge, pentagonal prism, hexagonal prism, and/or pentagrammic prism shape. As noted herein, the first central axis 380 and the second central axis 382 extend longitudinally through a center of the first magnet 144 and the second magnet 322.

As discussed above, the first magnet 144 is intentionally misaligned with the second magnet 322 in order to create both the axial magnet force F1 and the perpendicular magnet force F2. This misalignment creates a stable temporary coupling, i.e., secure connection that may be removably attached, between the attachment assembly 120 and the mount assembly 110 when the attachment assembly 120 and the mount assembly 110 are attached. The misalignment also allows the attachment assembly 120 to be removed from the mount assembly 110 when needed. Therefore, the user can easily remove the attachment assembly 120 when a new attachment assembly is needed or if the user does not need to hold anything, i.e., the attachment assembly 120 can be removed when the user is not holding anything or does not need assistance at that time.

Still referring to FIG. 9, when the attachment assembly 120 is secured with the mount assembly 110, there is a space 402 positioned between the first magnet 144 and the second magnet 322, i.e., the first magnet 144 and the second magnet 322 are not in contact with each other. The recessed wall 292 within the third sidewall 290 creates the space 402 between the first magnet 144 and the second magnet 322. In some embodiments, the space 402 defines a distance D3 that is between about 0.1 mm and about 5 mm, or between about 0.1 mm and about 1 mm, or between about 0.2 mm and about 0.8 mm, or between about 0.3 mm and about 0.5 mm, or about 0.4 mm, or at least about 0.1 mm, or at least about 0.3 mm, or at least about 0.4 mm. The bigger the distance D3, the smaller the force between the first magnet 144 and the second magnet 322. Further, the smaller the distance D3, the larger the force between the first magnet 144 and the second magnet 322. As noted herein, the first magnet 144 is securely held within the aperture 220 and the second magnet 322 is securely held within the bore 360. However, in some embodiments, the first magnet 144 and/or the second magnet 322 may be removed from the mount assembly 110 and the attachment assembly 120, respectively.

Referring to FIGS. 2 and 9-13, a method of attaching the attachment assembly 120 to the mount assembly 110 is disclosed. Specifically, the flange 202 of the attachment assembly 120 is positioned above the slot 180 of the shaft mount 140. The user can then slide the flange 202 into the slot 180 until a bottom surface 410 of the flange 202 makes contact with (or is adjacent with) the floor 280 of the shaft mount 140 (see FIG. 9). Once the bottom surface 410 of the flange 202 is positioned in contact with the floor 280, the attachment assembly 120 is secured to the mount assembly 110. As noted herein, the first magnet 144 and the second magnet 322 will interact with each other once the flange 202 of the attachment assembly 120 is inserted into the slot 180 of the shaft mount 140. As illustrated in FIG. 9, the flange support 350 is configured to extend through the window 270 defined in the shaft mount 140. The above process is reversed to remove the attachment assembly 120 from the mount assembly 110. In particular, the attachment assembly 120 is lifted up and out of the slot 180 of the shaft mount 140.

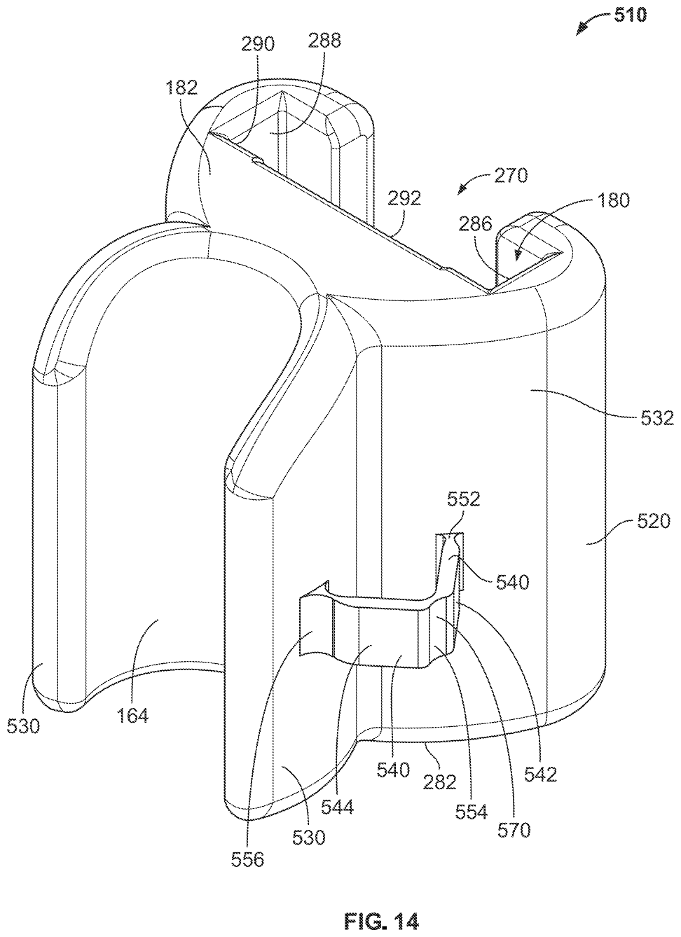

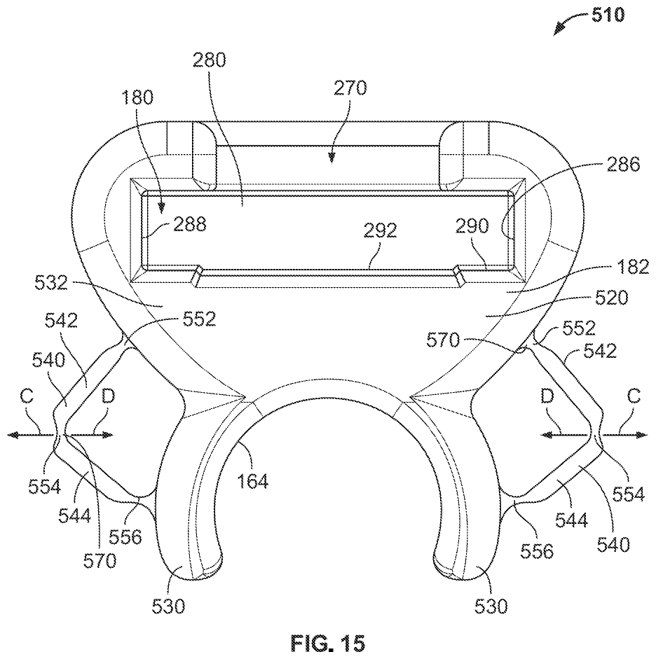

Referring to FIGS. 14 and 15, like reference numbers are used with regard to an alternative embodiment of a mount assembly 510. The mount assembly 510 may be used with the attachment assembly 120 to assist the user, as outlined above. Similar to the mount assembly 110, the mount assembly 510 comprises a shaft mount 520, the mounting pin 142 (not shown), and the first magnet 144 (not shown). The shaft mount 520 comprises flexible arms 530 that extend from a housing 532 of the shaft mount 520. As noted herein, the mount assembly 510 is similar to the mount assembly 110 except for the flexible arms 530. Specifically, as illustrated in FIG. 15, the mount assembly 510 comprises a plurality of linkage members 540 on both sides of the flexible arms 530. The plurality of linkage members 540 are attached to each of the flexible arms 530, and the plurality of linkage members 540 may use flexible joints or use traditional joints. Thus, the plurality of linkage members 540 may be flexible linkage members. As further noted herein, in some embodiments, FIG. 15 also comprises a similar distance D1 and a similar distance D4 as described above with respect to FIG. 11.

Referring to FIG. 15, each of the plurality of linkage members 540 comprises a first linkage member 542 and a second linkage member 544. The first linkage member 542 is attached to the housing 532 of the shaft mount 520 by a first joint 552, the first linkage member 542 is attached to the second linkage member 544 by a second joint 554, and the second linkage member 544 is attached to one of the flexible arms 530 by a third joint 556. Therefore, the plurality of linkage members 540 and the shaft mount 520 may take the shape of a four-bar component, i.e., the housing 532 of the shaft mount 520 is the first link, the first linkage member 542 is the second link, the second linkage member 544 is the third link, and one of the flexible arms 530 is the fourth link. As noted herein, the shaft mount 520 may comprise more or fewer linkage members 542, 544 and/or joints 552, 554, 556 than illustrated. The plurality of linkage members 540 work to increase ease of attachment by requiring less or no initial deflection of the flexible arms 530 during attachment. The user can manually deflect the plurality of linkage members 540 until the driver arm snaps past the dead center location of the respective four-bar component, and locks the mount assembly 510 on the shaft 150 of the movement assist device 102. This method of attachment provides similar attachment forces to the mount assembly 110 described above. The plurality of linkage members 540 may be formed by either a flexure component or a component with traditional hinges. In some embodiments, the flexible arms 530 may be thinner than the flexible arms 162 described above. As noted herein, the first joint 552, the second joint 554, and the third joint 556 form a plurality of joints 570. In some embodiments, the plurality of joints 570 and/or the linkage members 540 may be rigid. Further, in some embodiments, the plurality of joints 570 and/or the plurality of linkage members 540 may be compliant or flexible.

Still referring to FIG. 15, a method of securing the mount assembly 510 to the movement assist device 102 is disclosed. Specifically, the user aligns the mount assembly 510 with the shaft 150 of the movement assist device 102. Similar to the mount assembly 510, the mounting pin 142 (see FIG. 1) may or may not be used with the mount assembly 510 to secure the mount assembly 510 to the movement assist device 102. Once the mount assembly 510 is aligned with the shaft 150 and/or with one of the locating holes 240 on the shaft 150, the user can push or pull the first linkage member 542, the second linkage member 544, and/or the second joint 554 on both sides of the flexible arms 530 in the direction of arrows C. By moving the plurality of linkage members 540 in the direction of arrows C, the flexible arms 530 will move away from each other and spread apart. The user can then move the mount assembly 510 on the shaft 150 of the movement assist device 102. Once the mount assembly 510 is on the shaft 150 of the movement assist device 102, the user can then push or pull the first linkage member 542, the second linkage member 544, and/or the second joint 554 on both sides of the flexible arms 530 in the direction of arrows D, i.e., toward a center of the flexible arms 162. By moving the plurality of linkage members 540 in the direction of arrows D, the flexible arms 530 can close together and securely clamp onto the shaft 150 of the movement assist device 102. In order to disengage the mount assembly 510 from the shaft 150 of the movement assist device 102, the user can move the first linkage member 542, the second linkage member 544, and/or the second joint 554 in the direction of arrows C. In some embodiments, the user can just move the second joint 554 in the direction of arrows C or arrows D to secure and disengage the mount assembly 510 to the movement assist device 102. As noted herein, the flexible arms 530 may comprise similar surface roughness, gripping features, and/or a thin film layer as described above with respect to the flexible arms 162.

The crutch aid 100 is configured to advantageously assist the user through everyday activity. As discussed above, the mount assembly 110, 510 can be used with various types of attachment assemblies 120 depending on the needs of the user. Therefore, the user can simply remove one attachment assembly 120, e.g., a cupholder, and replace it with another attachment assembly 120, e.g., a hook or holding arm, depending on the activity being performed. In some embodiments, no attachment assembly 120 may be secured onto the mount assembly 110, 510. As noted herein, the crutch aid 100 can come in a variety of sizes. In particular, the crutch aid 100 may comprise a kid size for smaller movement assist devices 102 and an adult size for larger movement assist devices 102. Further, as noted herein, the crutch aid 100 is an entirely passive device. However, in some embodiments, the crutch aid 100 may include electronics and/or sensors therein or thereon. Further, it is contemplated that the crutch aid 100 may be sold in a kit. Specifically, the kit may include the mount assembly 110, 510 and one or more attachment assemblies 120. The attachment assemblies 120 may be the same type or different. In some embodiments, different types of attachment assemblies 120 may be sold by themselves.

Any of the embodiments described herein may be modified to include any of the structures or methodologies disclosed in connection with other embodiments. Further, although directional terminology, such as front, back, upper, lower, vertical, horizontal, etc. may be used throughout the present specification, it should be understood that such terms are not limiting and are only utilized herein to convey the orientation of different elements with respect to one another.

### INDUSTRIAL APPLICABILITY

Movement assist devices are commonly used to assist people with physical disabilities, the handicapped, and individuals recovering from injuries or surgery. Movement assist devices can take up a lot of hand space or require a lot of effort to use. Movement assist device aids assist individuals with everyday tasks who use movement assist devices.

We claim:

1. A movement assist device aid, comprising:
a mount assembly, the mount assembly includes a shaft mount and a first magnet positioned within the shaft mount, the first magnet comprises a first central axis; and
an attachment assembly, the attachment assembly comprises a second magnet, the second magnet comprises a second central axis,
wherein the first magnet of the mount assembly and the second magnet of the attachment assembly are configured to magnetically engage with each other to secure the attachment assembly to the mount assembly, and
wherein the first central axis of the first magnet is offset from the second central axis of the second magnet when the attachment assembly is secured to the mount assembly.

2. The movement assist device aid of claim 1, wherein the attachment assembly is a cup holder.

3. The movement assist device aid of claim 1, wherein a slot extends into an upper surface of the shaft mount.

4. The movement assist device aid of claim 3, wherein the shaft mount includes an aperture that extends through the shaft mount, and
wherein the first magnet is positioned within the aperture.

5. The movement assist device aid of claim 3, wherein the attachment assembly includes a flange that is configured to mate within the slot of the shaft mount to attach the attachment assembly to the mount assembly.

6. The movement assist device aid of claim 5, wherein the flange comprises a bore therein, and
wherein the bore extends into an outer surface of the flange and is configured to receive and retain the second magnet therein.

7. A movement assist device aid, comprising:
a mount assembly, the mount assembly includes a shaft mount, a mounting pin, and a first magnet, the mount assembly is configured to be removably attached to a crutch; and
an attachment assembly, the attachment assembly includes an attachment element and a second magnet, the attachment assembly is configured to be removably attached to the mount assembly,
wherein the crutch includes a grip, and
wherein the mount assembly is attached to the crutch above the grip in a first configuration.

8. The movement assist device aid of claim 7, wherein the attachment element is a cup holder.

9. The movement assist device aid of claim 7, wherein the mounting pin is configured to be inserted into a locating hole of the crutch.

10. The movement assist device aid of claim 7, wherein the shaft mount includes a pair of flexible arms that form a concave surface that is configured to contact the crutch.

11. The movement assist device aid of claim 10, wherein the mounting pin extends into an aperture that extends through the concave surface of the flexible arms.

12. The movement assist device aid of claim 7, wherein the first magnet is in contact with the mounting pin.

13. A movement assist device aid, comprising:
a mount assembly, the mount assembly includes a shaft mount that comprises a housing and flexible arms; and
an attachment assembly, the attachment assembly configured to be removably attached to the mount assembly,
wherein the flexible arms are configured to secure the movement assist device aid to a movement assist device.

14. The movement assist device aid of claim 13, wherein the shaft mount includes a plurality of linkage members on both sides of the flexible arms.

15. The movement assist device aid of claim 14, wherein the housing, the flexible arms, and the plurality of linkage members define a four-bar component on both sides of the flexible arms.

16. The movement assist device aid of claim 14, wherein a plurality of joints are connected with the plurality of linkage members.

17. The movement assist device aid of claim 16, wherein movement of the plurality of linkage members and the plurality of joints cause deflection of the flexible arms.

18. The movement assist device aid of claim 13, wherein the attachment assembly is a cup holder.

19. The movement assist device aid of claim 13, wherein the mount assembly includes a first magnet and the attachment assembly includes a second magnet, and
wherein the first magnet and the second magnet are configured to magnetically engage with each other to secure the attachment assembly to the mount assembly.

20. The movement assist device aid of claim 19, wherein the first magnet is coaxially offset with the second magnet when the attachment assembly is secured to the mount assembly.
